(19) United States
(12) Patent Application Publication
(10) Pub. No.: US 2025/0112581 A1
(43) Pub. Date: Apr. 3, 2025

(54) MOTOR CONTROL DEVICE AND PARKING LOCK DEVICE

(71) Applicant: MIKUNI CORPORATION, Tokyo (JP)

(72) Inventor: Tomihiro KANAZAWA, Odawara-shi (JP)

(21) Appl. No.: 18/789,965

(22) Filed: Jul. 31, 2024

(30) Foreign Application Priority Data
Sep. 29, 2023 (JP) 2023-169629

(51) Int. Cl. H02P 27/08; F16H 63/34; H02K 11/215; H02P 21/00; H02P 21/18; H02P 25/22

(52) U.S. Cl. CPC H02P 27/085; F16H 63/3466; H02K 11/215; H02P 21/0021; H02P 21/18; H02P 25/22

(57) ABSTRACT

A control device for a motor includes: a position determination part that determines whether an angular position of a rotor obtained from a detection signal of a Hall element has reached a target angular position; and a control mode switching part that switches a control mode between a feedback control mode, in which energizing control is performed for a pair of phase coils corresponding to the angular position among a three-phase coil at an output decided by feedback control based on a deviation between the angular position and the target angular position, and a stop control mode in which energizing control is performed for last energized coils that have been energized last in the feedback control mode among the three-phase coil. The control mode switching part switches the control mode from the feedback control mode to the stop control mode when the angular position has reached the target angular position.

### TECHNICAL FIELD

The present disclosure relates to a motor control device and a parking lock device.

### BACKGROUND

Conventionally, a three-phase motor control device that controls a three-phase motor based on a detection signal of a Hall element is known.

For example, Patent Document 1 describes a device that controls a three-phase DC motor based on a signal obtained by converting an output signal of a Hall IC with a pre-prepared table when it is determined that adjustment of the rotation stop position should be started based on the rotation speed of the three-phase DC motor and the number of remaining pulses until rotation stop.

### CITATION LIST

### Patent Literature

Patent Document 1: JP2022-43912A

### SUMMARY

Depending on the intended use of a motor, position feedback control, which controls the motor at an output decided based on a deviation (position deviation) between the angular position of the rotor obtained from a detection signal of the Hall element and the target angular position, is desired.

For example, a parking lock device requires a parking lock pole to move quickly between the locked position, where the axle is fixed, and the unlocked position, where the fixation of the axle is released, so position feedback control of the motor (parking lock actuator) is desired.

However, when position feedback control is used to stop the rotor at the target angular position, even if the angular position of the rotor reaches the target angular position and the position deviation becomes zero, the angular position of the rotor may pass the target angular position due to an external force acting on the motor output shaft. For example, if a decelerator is connected to the motor output shaft, an external force can act on the rotor via the motor output shaft from the gear of the decelerator that is trying to continue rotating due to inertia.

In this case, unless the rotor rotates further and a Hall element detection signal indicating a new angular position is received, correction of the rotor stop position by feedback control mode cannot be expected, and precision in the rotor stop position is reduced.

The control device described in Patent Document 1 outputs a PWM signal corresponding to the speed specified by a microcontroller (before the start of braking) or a fixed PWM signal for braking (after the start of braking) to the motor driver in the normal mode and does not perform feedback position control.

In view of the above, an object of at least some embodiments of the present invention is to provide a motor control device and a parking lock device that can achieve both rapid reaching of the angular position of the rotor to the target angular position and high precision in the rotor stop position.

A motor control device according to at least some embodiments of the present invention is a control device for a motor with a stator including a three-phase coil, a rotor including a magnet disposed opposite the stator, and a Hall element for generating a detection signal indicating an angular position of the rotor. The control device includes: a position determination part configured to determine whether the angular position of the rotor obtained from the detection signal of the Hall element has reached a target angular position of the rotor; and a control mode switching part configured to switch a control mode between a feedback control mode in which energizing control is performed for a pair of phase coils corresponding to the angular position among the three-phase coil at an output decided by feedback control based on a deviation between the angular position of the rotor obtained from the detection signal of the Hall element and the target angular position and a stop control mode in which energizing control is performed for last energized coils that have been energized last in the feedback control mode among the three-phase coil. The control mode switching part is configured to switch the control mode from the feedback control mode to the stop control mode when the position determination part determines that the angular position has reached the target angular position.

In at least some embodiments of the present invention, by operation of the control mode switching part, the control mode shifts from the feedback control mode to the stop control mode when the rotor reaches the target angular position, and energizing control is performed for the coils that have been energized last in the feedback control mode (last energized coils).

Therefore, even if the rotor passes the target angular position, a torque suitable for returning the rotor to the target angular position is applied to the rotor, regardless of receiving the next Hall element detection signal indicating a new angular position of the rotor, achieving high precision in the rotor stop position.

Thus, the feedback control mode and stop control mode make it possible to achieve both rapid reaching of the angular position of the rotor to the target angular position and high precision in the rotor stop position.

### BRIEF DESCRIPTION OF DRAWINGS

FIG. 1 is a hardware configuration diagram of a control device for a motor according to an embodiment.

FIG. 2 is a schematic diagram showing a configuration of a motor according to an embodiment.

FIG. 3A is a schematic diagram of a parking lock device according to an embodiment, where the parking lock device is in the unlocked state.

FIG. 3B is a schematic diagram of the parking lock device according to an embodiment, where the parking lock device is in the locked state.

FIG. 4 is a functional block diagram of the control device according to an embodiment.

FIG. 5 is a schematic diagram showing the transition of the energizing pattern of the three-phase coil according to an embodiment.

FIG. 6 is a timing chart showing an example of detection signals of Hall elements according to an embodiment.

FIG. 7 is a timing chart showing an example of the operation of the control device according to an embodiment.

FIG. 8 is a flowchart showing the control flow of the control device according to an embodiment.

FIG. 9 is a functional block diagram of the control device according to another embodiment.

FIG. 10A is a diagram showing an example of the energization pattern in the stop control mode.

FIG. 10B is a diagram showing an example of the energizing pattern in the high-precision stop control mode.

### DETAILED DESCRIPTION

Embodiments of the present invention will now be described in detail with reference to the accompanying drawings. It is intended, however, that details described in the embodiments or shown in the drawings shall be interpreted as illustrative only and not intended to limit the scope of the present invention.

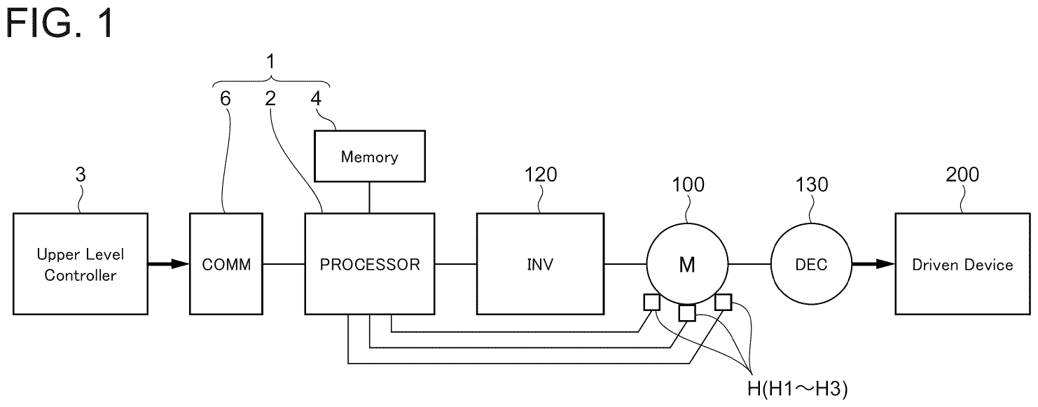

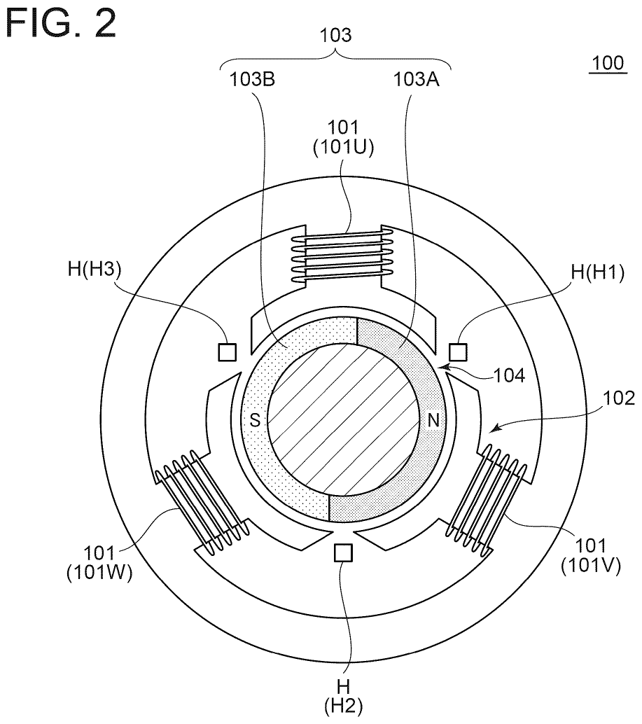

FIG. 1 is a hardware configuration diagram of a control device for a motor according to an embodiment. FIG. 2 is a schematic diagram showing a configuration of a motor according to an embodiment.

In some embodiments, as shown in FIG. 1, a control device 1 for a motor 100 includes a processor 2 for processing information acquired from an external device (host controller 3 or Hall element H described below) and computing a control command for controlling the motor 100.

The processor 2 may be a central processing unit (CPU) of a microcontroller (MCU: Micro Controller Unit) or a microcomputer.

The control device 1 has a storage part 4 including RAM (Random Access Memory) and ROM (Read Only Memory) as hardware associated with the processor 2. The ROM of the storage part 4 stores programs executed by the processor 2 and information necessary for processing by the processor 2. The RAM of the storage part 4 is used to read and write temporary data during program execution by the processor 2.

The storage part 4 may be RAM or ROM embedded in a microcontroller or a microcomputer.

In the embodiment shown in FIG. 1, the control device 1 includes a communication circuit 6 that is responsible for communication between the processor 2 and the host controller 3. The processor 2 acquires the target position of the motor 100 from the host controller 3 via the communication circuit 6 and uses this target position for generating a control command. Details of the control command calculation function in the processor 2 are described below.

In some embodiments, the control device 1 provides a switching control signal as the control command to an inverter 120 for energizing the coil (motor coil) of the motor 100.

The inverter 120 has a plurality of switching elements and switches each switching element ON and OFF according to the switching control signal from the control device 1. The switching control signal may be a pulse width modulation (PWM) signal that adjusts the duty ratio by changing the percentage of ON time while maintaining a constant switching cycle.

Thus, the motor 100 is driven under the control of the control device 1 by controlling the power supplied to the motor coil by the inverter 120 according to the switching control signal.

In some embodiments, the motor 100 to be controlled by the control device 1 is a brushless DC motor driven by DC current.

The motor 100 shown in FIG. 2 is a brushless DC motor that includes a stator 102 with a three-phase coil 101 (101U, 101V, 101W) and a rotor 104 with a magnet 103 (103A, 103B) disposed opposite the stator 102. The magnet 103 is a permanent magnet.

In the exemplary embodiment shown in FIG. 2, the motor 100 has a 2-pole, 3-slot structure that includes a magnet 103 composed of a set of N-pole 103A and S-pole 103B and a three-phase coil 101 composed of three coils (101U to 101W) of phases U, V and W.

However, in the present invention, the number of pole pairs of the magnet 103 and the number of coils of the three-phase coil 101 are not limited. In other embodiments, the motor 100 may have any structure, such as 4-pole 6-slot, 6-pole 9-slot, 8-pole 9-slot, or 10-pole 12-slot.

In the exemplary embodiment shown in FIG. 2, the motor 100 is an inner rotor motor in which the rotor 104 rotates on the radially inner side of the stator 102.

In other embodiments, the motor 100 may be an outer rotor motor in which the rotor 104 rotates on the radially outer side of the stator 102.

As shown in FIGS. 1 and 2, the motor 100 includes a Hall element H for generating a detection signal indicating the rotor angular position of the motor 100. The detection signal of the Hall element H is processed by the processor 2 of the control device 1 to generate a control command.

Although three Hall elements H (H1 to H3) are illustrated in FIGS. 1 and 2, the number of Hall elements H is not limited to this example.

In some embodiments, as shown in FIG. 2, a plurality of Hall elements H (H1 to H3) are arranged at even intervals in the circumferential direction in close proximity to the magnet 103 of the rotor 104 in the radial direction. In this case, the Hall elements H (H1 to H3) obtain detection signals indicating the angular position of the rotor 104 by detecting the magnetic field generated by the magnet 103 of the rotor 104.

In some other embodiments, Hall elements H are arranged in close proximity to another magnet which rotates with the rotor 104 of the motor 100. In this case, the Hall elements H obtain detection signals indicating the angular position of the rotor 104 by detecting the magnetic field generated by the other magnet different from the magnet 103 of the rotor 104.

In the exemplary embodiment shown in FIG. 1, the output shaft of the motor 100 to be controlled by the control device 1 is connected to a driven device 200 via a decelerator 130. The driven device 200 receives power from the motor 100 via the decelerator 130 and is driven.

In other embodiments, the driven device 200 receives power directly from the motor 100 without the decelerator 130. In this case, the driven device 200 may be equipped with a transmission mechanism inside the driven device 200.

The motor 100 which operates under the control of the control device 1 with the above configuration is applicable to an actuator for any driven device 200. For example, the motor 100 may be an actuator of a parking lock device installed in a vehicle.

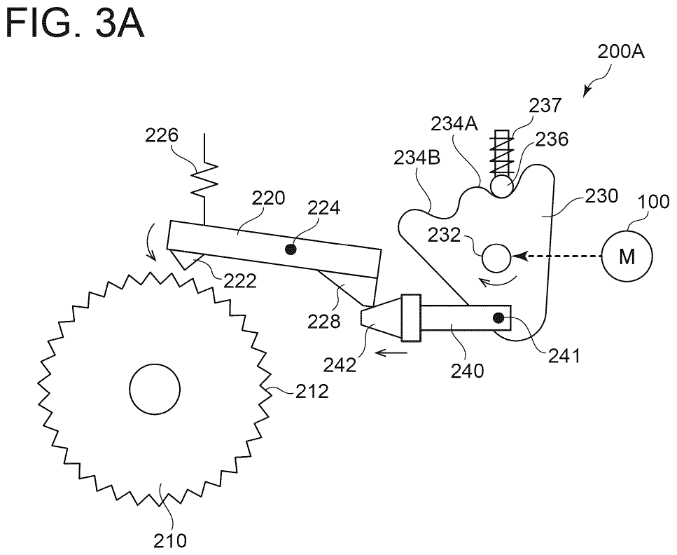

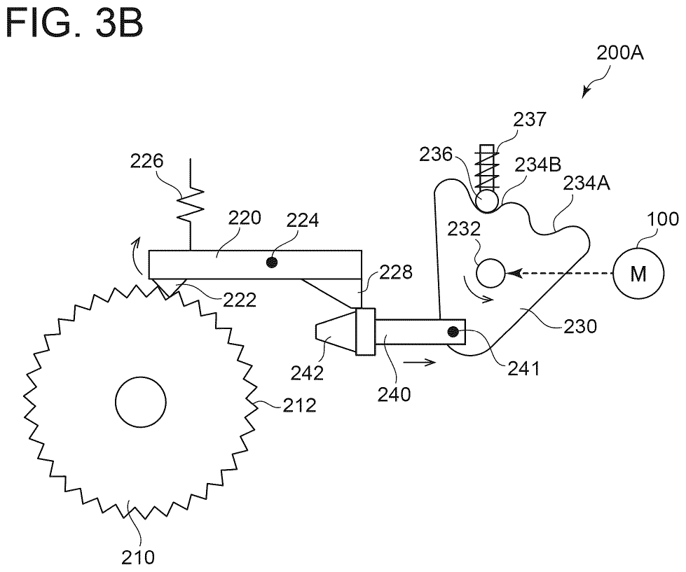

FIGS. 3A and 3B are schematic diagrams of a parking lock device according to an embodiment. FIG. 3A shows the parking lock device in the unlocked state, and FIG. 3B shows the parking lock device in the locked state.

In some embodiments, as shown in FIGS. 3A and 3B, the parking lock device 200A includes a parking lock gear 210 and a parking lock pole 220 that can engage the parking lock gear 210.

The parking lock gear 210 is connected to an axle of a vehicle (not shown). The parking lock gear 210 may be secured directly to the axle or indirectly to the axle via another component.

The parking lock pole 220 has a projection 222 at its tip that can engage teeth 212 of the parking lock gear 210. The parking lock pole 220 is disposed rotatably about a pivot axis 224, and the projection 222 is biased in a direction away from the parking lock gear 210 by a biasing member 226. The biasing member 226 may be a spring.

The parking lock pole 220 is configured to move between an unlocked position (FIG. 3A) disengaged from the parking lock gear 210 and a locked position (FIG. 3B) engaging the parking lock gear 210 by power from the motor 100 operating under the control of the control device 1.

Specifically, in the unlocked position, the projection 222 of the parking lock pole 220 retracts from the teeth 212 of the parking lock gear 210, and the axle is unlocked by the parking lock device 200A. When the parking lock pole 220 receives power from the motor 100 in the unlocked position, it rotates in the direction of the arrow in FIG. 3A around the pivot axis 224 against the force exerted by the biasing member 226. As a result, the parking lock pole 220 reaches the locked position shown in FIG. 3B, where the projection 222 of the parking lock pole 220 engages the teeth 212 of the parking lock gear 210. Thus, the axle is locked by the parking lock device 200A. When the parking lock pole 220 receives power from the motor 100 in the locked position, it rotates in the direction of the arrow in FIG. 3B around the pivot axis 224 to return to the unlocked position shown in FIG. 3A.

In some embodiments, the parking lock device 200A further includes one or more power transmission members (230, 240) for transmitting power from the motor 100 to the parking lock pole 220.

In the exemplary embodiment shown in FIGS. 3A and 3B, the power transmission members (230, 240) include a parking lock lever 230 configured to be rotated by power from the motor 100 and a parking lock rod 240 disposed between the parking lock lever 230 and the parking lock pole 220.

The parking lock lever 230 includes a detent shaft 232 connected to the output shaft of the motor 100 (or in the case of the motor 100 with a decelerator 130, the output shaft of the decelerator 130) and a pair of recesses (234A, 234B) capable of engaging a stopper 236.

Of the pair of recesses (234A, 234B), the first recess 234A is a recess for the stopper 236 to engage in the unlocked position of the parking lock pole 220 shown in FIG. 3A. In contrast, the second recess 234B is a recess for the stopper 236 to engage in the locked position of the parking lock pole 220 shown in FIG. 3B.

The stopper 236 is biased toward the parking lock lever 230 by a biasing member 237, which may be a spring. This allows the stopper 236 to move between the pair of recesses (234A, 234B) while maintaining contact with the parking lock lever 230 when the parking lock lever 230 is rotated by power of the motor 100 input to the detent shaft 232. Specifically, the stopper 236 that engages the first recess 234A in the unlocked position of the parking lock pole 220 shown in FIG. 3A moves toward the second recess 234B along the outer edge of the parking lock lever 230 with the clockwise rotation of the parking lock lever 230. In contrast, the stopper 236 that engages the second recess 234B in the locked position of the parking lock pole 220 shown in FIG. 3B moves toward the first recess 234A along the outer edge of the parking lock lever 230 with the counterclockwise rotation of the parking lock lever 230.

The parking lock rod 240 is attached to the portion of the parking lock lever 230 opposite the pair of recesses (234A, 234B) across the detent shaft 232. The parking lock rod 240 is attached to the parking lock lever 230 rotatably about a pivot axis 241.

The parking lock rod 240 is guided forward or backward in the axial direction of the parking lock rod 240 by a guide member (not shown). Therefore, when the parking lock lever 230 rotates clockwise in the unlocked position of the parking lock pole 220 shown in FIG. 3A, the parking lock rod 240 moves axially forward toward the parking lock pole 220. In contrast, when the parking lock lever 230 rotates counterclockwise in the locked position of the parking lock pole 220 shown in FIG. 3B, the parking lock rod 240 moves axially backward away from the parking lock pole 220.

The parking lock rod 240 has a tapered portion 242 at the end opposite the end connected to the parking lock lever 230. On the other hand, the parking lock pole 220 has an engagement portion 228 at the end (base end of the parking lock pole 220) opposite the projection 222 across the pivot axis 224. The engagement portion 228 of the parking lock pole 220 can engage the tapered portion 242 of the parking lock rod 240. Thus, when the parking lock rod 240 moves forward, the position of engagement of the engagement portion 228 with the tapered portion 242 shifts toward the base end of the tapered portion 242, causing the parking lock pole 220 to rotate counterclockwise (see arrow in FIG. 3A). In contrast, when the parking lock rod 240 moves backward, the position of engagement of the engagement portion 228 with the tapered portion 242 shifts toward the tip end of the tapered portion 242, causing the parking lock pole 220 to rotate clockwise (see arrow in FIG. 3B).

Since the parking lock pole 220 is biased in the direction away from the parking lock gear 210 by the biasing member 226, contact between the engagement portion 228 and the tapered portion 242 is maintained even if the parking lock rod 240 is in the backward position as shown in FIG. 3B.

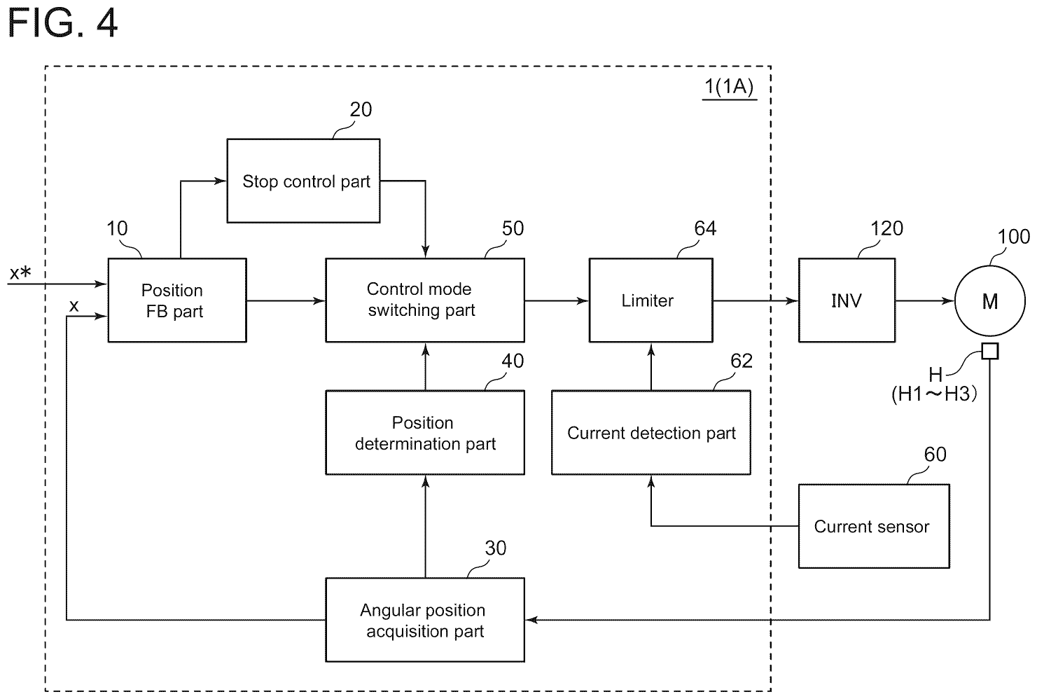

Next, with reference to FIG. 4, the function of the control device 1 to generate a control command will be described.

FIG. 4 is a functional block diagram of the control device 1 according to an embodiment. Each function of the control device 1 shown in FIG. 4 is realized by the hardware configuration of the control device 1 (processor 2 and storage part 4) described above with reference to FIG. 1.

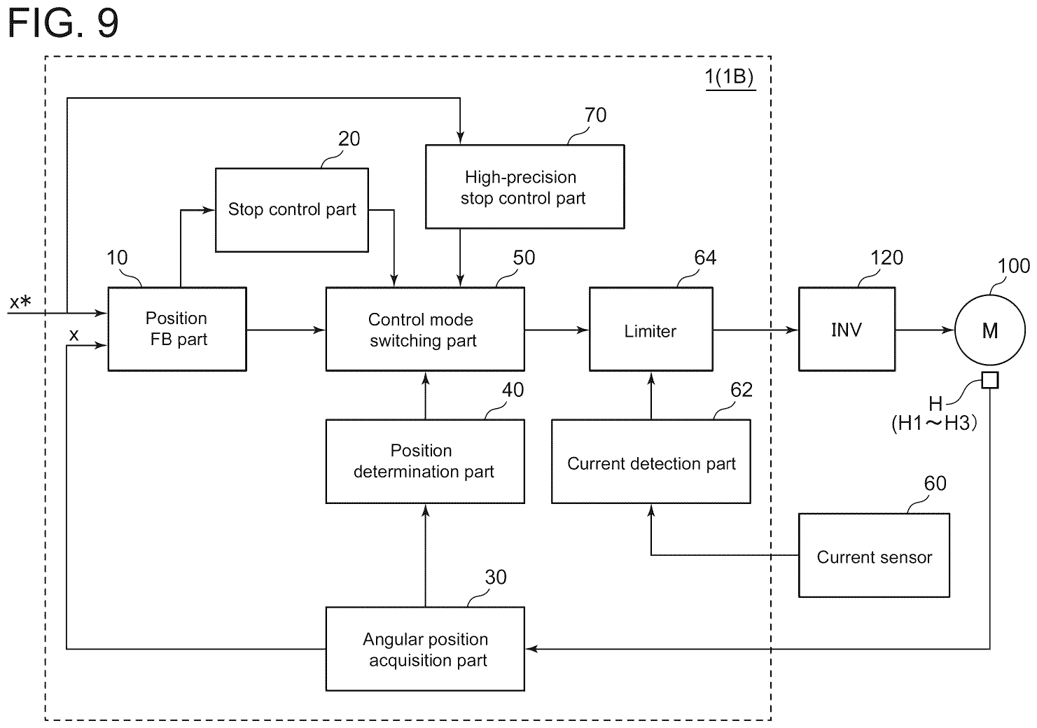

Herein, when distinguishing the control device 1 of the embodiment shown in FIG. 4 from the control device 1 of the embodiment shown in FIG. 9 below, the former may be referred to as control device 1A and the latter as control device 1B.

In some embodiments, as shown in FIG. 4, the control device 1 includes a position feedback part 10 that is responsible for feedback control mode and a stop control part 20 that is responsible for stop control mode. The control device 1 can selectively execute either the feedback control mode or the stop control mode.

The position feedback part 10 generates a control command for energizing control of the motor coil at an output decided based on a deviation Δx between the angular position x of the rotor 104 obtained from a detection signal of the Hall element H (H1 to H3) and the target angular position x*. Specifically, the position feedback part 10 calculates a duty ratio that enables energization control at the output decided based on the deviation Δx and generates a switching control signal corresponding to this duty ratio. The switching control signal may be a PWM control signal as described above.

For deciding the output (or duty ratio) based on the deviation Δx (=x*−x), calculations may be performed based on P control, PI control, or PID control. Here, P control calculates the command value from a proportional term that is proportional to the deviation Δx. PI control calculates the command value by considering the integral term of the deviation Δx in addition to the proportional term of the deviation Δx. PID control calculates the command value by considering the proportional term of the deviation Δx, the integral term of the deviation Δx, and the derivative term of the deviation Δx.

The target angular position x* of the rotor 104 used by the position feedback part 10 for calculation may be input to the processor 2 via the communication circuit 6 from the host controller 3 described with reference to FIG. 1.

During execution of the feedback control mode by the position feedback part 10, the rotor 104 of the motor 100 changes its angular position x over time until the target angular position x* is reached. Therefore, the coil to be energized must be appropriately selected from among the three-phase coil 101 (101U to 101W) of the motor 100 according to the angular position x of the rotor 104.

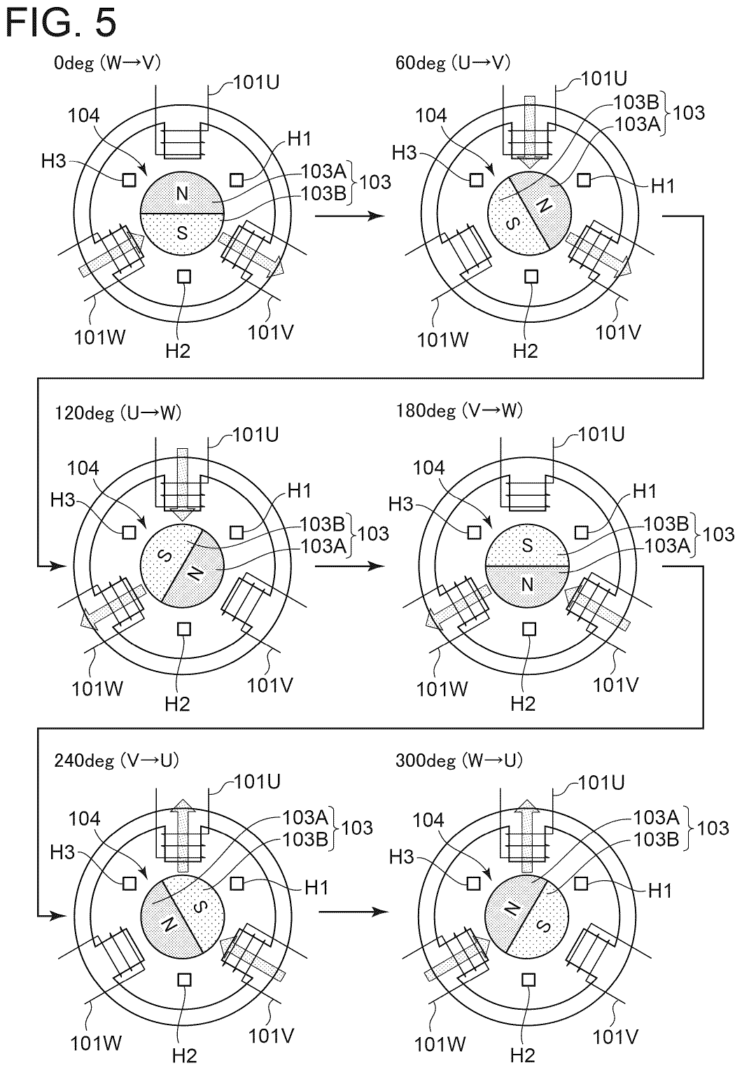

Referring to FIG. 5, the transition of the energizing pattern of the three-phase coil 101 in response to changes in the angular position x of the rotor 104 will be described.

FIG. 5 is a schematic diagram showing the transition of the energizing pattern of the three-phase coil 101 according to an embodiment. The arrows indicated on the pair of coils, which are to be energized among the three-phase coil 101 in FIG. 5, represent the directions of magnetic fluxes generated by the energized coils.

The notation 0 deg to 300 deg in FIG. 5 indicates the electrical angle of the motor 100 in each state. FIG. 5 shows the coil energizing pattern for the 2-pole, 3-slot motor 100 shown in FIG. 2, where the electrical and mechanical angles match. However, in motors 100 of other structures, the electrical angle may be different from the mechanical angle. For example, in the case of a 4-pole, 6-slot motor 100, the three-phase coil is arranged in the order 101U, 101V, 101W, 101U, 101V, 101V, and 101W at 60-degree intervals in the circumferential direction, and during one rotation of the rotor 104 (mechanical angle 0 deg to 360 deg), the electrical angle changes for two cycles (720 deg). Even in the case of motors 100 with structures other than 2-pole, 3-slot, the energizing pattern in each state of the electrical angle from 0 deg to 300 deg is the same as in the 2-pole, 3-slot motor shown in FIG. 5.

As shown in FIG. 5, when the current flows from phase W (101W) to phase V (101V) at an electrical angle of 0 deg (W→V), the coil 101W of phase W generates a radially inward magnetic flux, and the coil 101V of phase V generates a radially outward magnetic flux. The composite magnetic flux of these fluxes gives a torque to the magnet 103 at the angular position corresponding to an electrical angle of 0 deg to rotate the rotor 104 clockwise.

When the angular position x of the rotor 104 changes and the electrical angle reaches 60 deg, the energizing pattern changes to the pattern where the current flows from phase U (101U) to phase V (101V) (U→V). As a result, the coil 101U of phase U generates a radially inward magnetic flux, and the coil 101V of phase V generates a radially outward magnetic flux. The composite magnetic flux of these fluxes gives a torque to the magnet 103 at the angular position corresponding to an electrical angle of 60 deg to rotate the rotor 104 clockwise.

Thereafter, similarly, the U→W energizing pattern is selected at an electrical angle of 120 deg, the V→W energizing pattern at an electrical angle of 180 deg, the V→U energizing pattern at an electrical angle of 240 deg, and the W→U energizing pattern at an electrical angle of 300 deg. The next energizing pattern after W→U is again selected to be the W→V energizing pattern, returning to an electrical angle of 0 deg.

As described above, the position feedback part 10 generates a control command in the feedback control mode by determining the output (or duty ratio) based on the deviation Δx and selecting the energizing pattern according to the angular position x of the rotor 104.

In contrast, the stop control part 20 generates a control command in the stop control mode, where energizing control is performed for the last energized coils that have been energized last in the feedback control mode. In other words, the stop control part 20 generates a control command for energizing control of the last energized coils according to the last energizing pattern (final energizing pattern) in the feedback control mode.

In some embodiments, as shown in FIG. 4, the stop control part 20 receives information about the last energized coils from the position feedback part 10 while the control device 1 is executing the feedback control mode. The stop control part 20 prepares for switching from the feedback control mode to the stop control mode by always maintaining the latest information about the last energized coils. In this case, the stop control part 20 may temporarily store the information about the last energized coils in the RAM of the storage part 4 and constantly update the information about the last energized coils temporarily stored in the RAM to the latest value.

In other embodiments, the stop control part 20 acquires information about the last energized coils from the position feedback part 10 only when the angular position x of the rotor 104 reaches an electrical angle that is one before the target angular position x* among the electrical angles (0 deg, 60 deg, 120 deg, 180 deg, 240 deg, 300 deg in the example shown in FIG. 5) corresponding to the switching timing of the energizing pattern.

The specific control command generation function of the stop control part 20 can be in various forms.

For example, with respect to the timing to start energizing the last energized coils in the stop control mode, in an embodiment, the stop control part 20 starts energizing control for the last energized coils immediately after the transition to the stop control mode. In other embodiments, the stop control part 20 starts energizing control for the last energized coils after a first specified time elapses from the time when the angular position x of the rotor 104 obtained from the detection signal of the Hall element H reaches the target angular position x*

With respect to the energizing duration in the stop control mode, in an embodiment, the stop control part 20 continues energizing control for the last energized coils for a predetermined time (second specified time).

Furthermore, with respect to the duty ratio in the stop control mode, in an embodiment, the stop control part 20 may perform energizing control for the last energized coils by PWM control based on a fixed duty ratio (second duty ratio), in contrast to the feedback control mode. The second duty ratio may be a specified value stored in the ROM of the storage part 4, and the stop control part 20 may acquire the second duty ratio from the storage part 4.

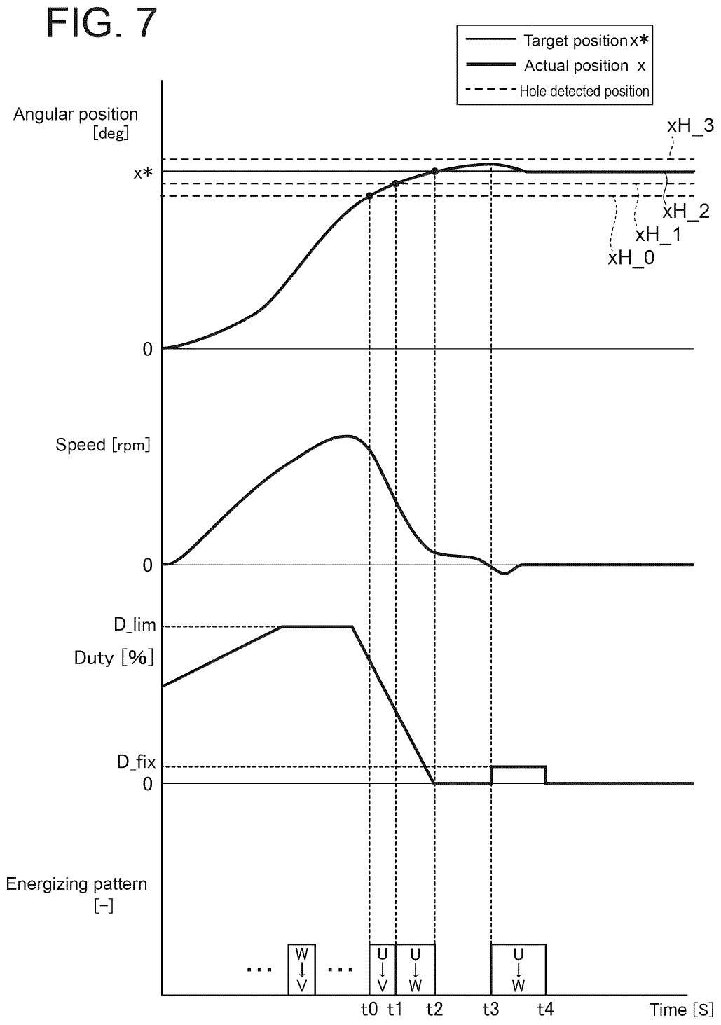

The above-described embodiments of the control command generation function of the stop control part 20 will be described in detail later with reference to FIG. 7.

In some embodiments, the control device 1 further includes, in addition to the position feedback part 10 and the stop control part 20 described above, an angular position acquisition part 30 configured to acquire the angular position x of the rotor 104, a position determination part 40 configured to determine the angular position of the rotor 104, and a control mode switching part 50 configured to switch the control mode.

The angular position acquisition part 30 acquires the angular position x of the rotor 104 from a detection signal of the Hall element H (H1 to H3).

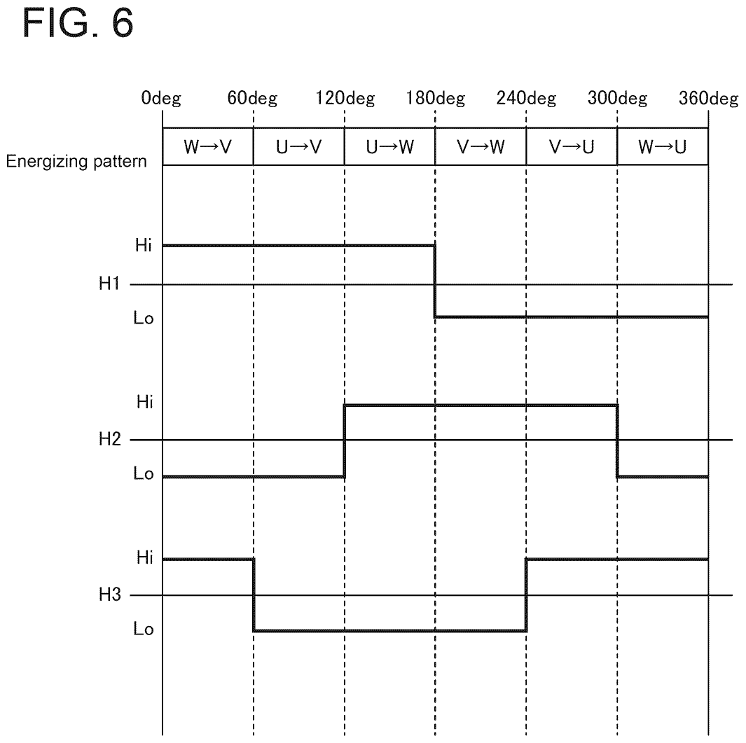

FIG. 6 is a timing chart showing an example of detection signals of Hall elements H according to an embodiment. The horizontal axis in FIG. 6 represents the electrical angle, and the energizing pattern means six different energizing patterns for the three-phase coil 101 (101U to 101W) shown in FIG. 5.

The detection signal level (Hi or Lo) of each of the Hall elements H1 to H3 fluctuates as the angular position x of the rotor 104 changes. Here, regarding the detection signal level of each Hall element H, Hi indicates the detection of the magnetic field created by N pole 103A of the magnet 103, and Lo indicates the detection of the magnetic field created by S pole 103B of the magnet 103.

As shown in FIG. 6, there are six combinations of detection signal levels Hi and Lo of the Hall elements H1 to H3. The angular position acquisition part 30 acquires the angular position x of the rotor 104 based on which of the six combinations of detection signal levels Hi and Lo of the Hall elements H1 to H3 is found. In this case, the angular position acquisition part 30 may acquire information on the angular position x of the rotor 104 corresponding to each combination of detection signal levels Hi and Lo of the Hall elements H1 to H3 from the ROM of the storage part 4.

Since the number of combinations of detection signal levels Hi and Lo of the Hall elements H1 to H3 is finite, the angular position x that can be acquired by the angular position acquisition part 30 is discrete. For example, in the example shown in FIG. 6, there are six combinations of detection signal levels Hi and Lo of the Hall elements H1 to H3, and the angular position acquisition part 30 can acquire the angular position x every 60 degrees.

The angular position x of the rotor 104 acquired by the angular position acquisition part 30 is sent to the position feedback part 10 and the position determination part 40 for generating a control command based on the deviation Δx in the feedback control mode, deciding the energizing pattern, and switching the control mode.

The position determination part 40 compares the angular position x of the rotor 104 acquired by the angular position acquisition part 30 from the detection signals of the Hall elements H (H1 to H3) with the target angular position x* to determine whether the angular position x of the rotor 104 has reached the target angular position x*

The comparison between the angular position x of the rotor 104 and the target angular position x* in the position determination part 40 may be combined with the function of calculating the deviation Δx (=x *−x) in the position feedback part 10. In this case, the position determination part 40 determines the position based on whether the value of deviation Δx calculated in the position feedback part 10 is zero or not.

The control mode switching part 50 selects either the feedback control mode or the stop control mode as the control mode of the control device 1 based on the determination result of the position determination part 40.

Specifically, the control mode switching part 50 selects the feedback control mode when the angular position x of the rotor 104 has not reached the target angular position x*, and selects the stop control mode when the angular position x of the rotor 104 reaches the target angular position x*.

In the exemplary embodiment shown in FIG. 4, the control mode switching part 50 receives control commands for the feedback control mode from the position feedback part 10 and for the stop control mode from the stop control part 20, and selects one of the control commands based on the determination result of the position determination part 40 to switch the control mode. Specifically, the control mode switching part 50 selects either the control command generated by the position feedback part 10 or the control command generated by the stop control part 20, and outputs the selected control command to the inverter 120.

In other embodiments, the control mode switching part 50 selects the control mode first based on the determination result of the position determination part 40, and causes either the position feedback part 10 or the stop control part 20 to generate a control command corresponding to the selected control mode. The position feedback part 10 and the stop control part 20 each generate a control command in response to the request from the control mode switching part 50, and the control command is input to the inverter 120 as the output signal from the control device 1.

In some embodiments, as shown in FIG. 4, the control device 1 further includes a limiter 64 that limits the duty ratio of the control command output from the control device 1. Additionally, the control device 1 further includes a current detection part 62 configured to detect the motor current based on a detection signal of a current sensor 60 for detecting the motor current and determine whether there is an overcurrent. The limiter 64 switches between limiting the duty ratio or not based on the determination result of the current detection part 62.

Thus, the functions of the current detection part 62 and the limiter 64 prevent excessive current from flowing to the three-phase coil 101 (101U to 101W) of the motor 100.

FIG. 7 is a timing chart showing an example of the operation of the control device 1 according to an embodiment. FIG. 7 shows an example of the timing chart, and the operation of the control device 1 is not limited to this example.

In FIG. 7, the three positions xH_0 to xH_2 with respect to the angular position x of the rotor 104 represent discrete angular positions obtained from detection signals of the Hall element H at time t0 to t2, respectively. The position xH_2 is the angular position of the rotor 104 obtained from the detection signal of the Hall element H when the angular position x of the rotor 104 reaches the target angular position x* at time t=t2, and xH_2=x*. The position xH_3 shown in FIG. 7 is the next position after the position xH_2 among the discrete angular positions that can be obtained from detection signals of the Hall element H.

In the exemplary embodiment shown in FIG. 7, the control device 1 executes control by the feedback control mode during a period (0≤t≤t2) until the angular position x of the rotor 104 reaches the target angular position x* (=xH_2). In the feedback control mode, PWM control is performed based on a variable duty ratio (first duty ratio) determined according to the deviation Δx between the angular position x of the rotor 104 and the target angular position x* The PWM control signal based on the first duty ratio is generated in the position feedback part 10 of the control device 1.

In the example shown in FIG. 7, the first duty ratio is limited by the soft-start function to suppress inrush current immediately after the motor 100 starts at t=0. After the motor 100 starts, the first duty ratio gradually increases over time. In the case where the control device 1 includes the limiter 64, the first duty ratio is limited below the limit value D_lim shown in FIG. 7. As the deviation Δx decreases, the first duty ratio decreases.

During execution of the feedback control mode by the control device 1, the angular position x of the rotor 104 is acquired by the angular position acquisition part 30 from detection signals of the Hall elements H (H1 to H3) according to the principle described above with reference to FIG. 6, and is sent to the position feedback part 10 for calculation of the deviation Δx.

As described above, the angular position of the rotor 104 acquired by the angular position acquisition part 30 is updated to the new position at the timing when the combination of detection signal levels Hi and Lo of the Hall elements H (H1 to H3) is switched. Therefore, even though the angular position x of the rotor 104 actually changes continuously, the angular position detected based on detection signals of the Hall elements H (H1 to H3) is discrete, as in xH_0 to xH_4 in FIG. 7.

During execution of the feedback control mode by the control device 1, the coils to be energized of the three-phase coil 110 (110U to 110W) and the direction of energization are selected according to the angular position x of the rotor 104, as described with reference to FIG. 5.

In the example shown in FIG. 7, after the current flows in the order of phase U and phase V (“U→V” energizing pattern) according to the angular position xH_0 of the rotor 104 at t=t0 (angular position of 60 deg in FIG. 5), the current flows in the order of phase U and phase W (“U→W” energizing pattern) according to the angular position xH_1 of the rotor 104 at t=t1 (angular position of 120 deg in FIG. 5).

In the feedback control mode, the coil energizing control is performed at an output (first duty ratio) determined by feedback control based on the deviation Δx between the angular position x of the rotor 104 and the target angular position x*. The feedback control mode is advantageous in that the angular position x of the rotor 104 can be quickly brought closer to the target angular position x* than when control is performed with a fixed duty ratio.

Also in FIG. 7, the first duty ratio is set to a relatively large value during the period when the deviation Δx is large after the motor 100 starts, resulting in a rapid increase in the rotation speed of the rotor 104 immediately after the motor 100 starts. This reduces the time required for the angular position x of the rotor 104 to reach the target angular position x*.

On the other hand, since the feedback control mode requires the deviation Δx to generate a control command, if the angular position x of the rotor 104 has passed the target angular position x*, unless the rotor 104 rotates further and a detection signal from the Hall element H indicating a new angular position (xH_3 in the example in FIG. 7) is received, correction of the rotor position by the feedback control mode cannot be expected.

Therefore, as shown in FIG. 7, the control device 1 shifts from the feedback control mode to the stop control mode when the angular position x of the rotor 104 reaches the target angular position x* (xH_2) by the operation of the control mode switching part 50.

As described above, in the stop control mode, energizing control is performed for the last energized coils that have been energized last in the feedback control mode, and the stop control part 20 generates a control command in the stop control mode. In the example shown in FIG. 7, “U→W” at t=t1 to t2 is the last energizing pattern, and the coil 101U of phase U and the coil 101W of phase W are the last energized coils. Therefore, in the example shown in FIG. 7, the control device 1 executes the stop control mode in which the coil energizing control is performed with the last energizing pattern of “U→W” at t=t3 to t4.

In the exemplary embodiment shown in FIG. 7, the control device 1 starts, as the stop control mode, energizing control for the last energized coils at t=t3 after a first specified time elapses from the time (t=t2) when the angular position x of the rotor 104 obtained from the detection signal of the Hall element H reaches the target angular position x*. In this example, the first specified time is t3-t2.

Further, in the example shown in FIG. 7, energizing control for the last energized coils by the stop control mode is continued for a second specified time (=t4-t3).

In the embodiment shown in FIG. 7, in contrast to the feedback control mode, in which PWM control is based on a variable first duty ratio according to the deviation Δx, the stop control part 20 performs energizing control for the last energized coils by PWM control based on a fixed duty ratio D_fix (second duty ratio).

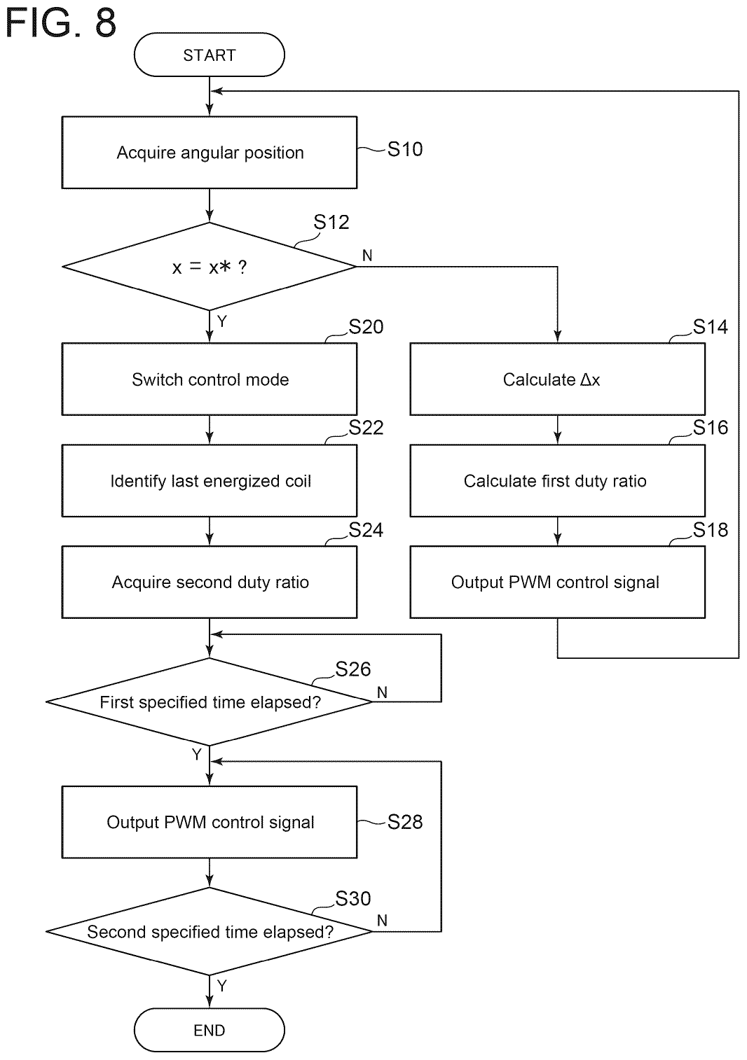

FIG. 8 is a flowchart showing the control flow of the control device 1 according to an embodiment.

As shown in the figure, in the control device 1, the angular position acquisition part 30 acquires the angular position x of the rotor 104 from the detection signal of the Hall element H (S10), and the position determination part 40 determines whether the angular position x has reached the target angular position x* (S12).

If the angular position x of the rotor 104 has not reached the target angular position x* (N in S12), the feedback control mode is selected by the control mode switching part 50. The position feedback part 10 calculates the deviation Δx between the angular position x of the rotor 104 and the target angular position x* (S14), further calculates the first duty ratio based on the deviation Δx (S16), and then generates a PWM control signal based on this first duty ratio as a control command in the feedback control mode. When the feedback control mode is selected by the control mode switching part 50, a PWM control signal based on the first duty ratio obtained by the position feedback part 10 is output to the inverter 120 as the control command from the control device 1 (S18). It then returns to S10, where the angular position x of the rotor 104 is acquired.

If the angular position x of the rotor 104 has reached the target angular position x* (Y in S12), the control mode of the control device 1 is switched from the feedback control mode to the stop control mode by the control mode switching part 50 (S20). In the stop control mode, the control device 1 outputs a control command generated by the stop control part 20. The stop control part 20 identifies the last energized coils subject to energizing control using the last energizing pattern in the feedback control mode (S22), and obtains the second duty ratio, which is a fixed value (S24). The stop control part 20 determines whether the first specified time has elapsed from the time when the angular position x of the rotor 104 reaches the target angular position x* (S26), and if the first specified time has elapsed (Y in S26), it generates a PWM control signal based on the second duty ratio to energize the last energized coils. This PWM control signal is then output to the inverter 120 as the control command from the control device 1 in the stop control mode (S28). The stop control part 20 determines whether the second specified time has elapsed from the start of energizing control for the last energized coils (S30), and continues to execute S28 until the second specified time elapses.

Next, with reference to FIG. 9, the control device 1B according to another embodiment different from the control device 1A shown in FIG. 4 will be described.

FIG. 9 is a functional block diagram of the control device 1B according to another embodiment. The control device 1B shown in the figure differs from the control device 1A in that it further includes a high-precision stop control part 70. The high-precision stop control part 70 generates a control command in the high-precision stop control mode in which the three-phase coil 101 (101U to 101W) is energized with a preset energizing pattern corresponding to the target angular position x*. The high-precision stop control part 70 may acquire the energizing pattern stored in the ROM of the storage part 4 and generate a control command in the high-precision stop control mode.

In an embodiment, the control device 1 starts outputting the control command by the high-precision stop control mode to the inverter 120 immediately after the end of energizing control with the last energizing pattern in the stop control mode.

The duty ratio and duration of the energizing control in the high-precision stop control mode may be fixed values determined in advance.

The following is an explanation of the energizing pattern in the high-precision stop control mode, comparing it with the stop control mode executed in the period from t2 to t4 in the timing chart shown in FIG. 7.

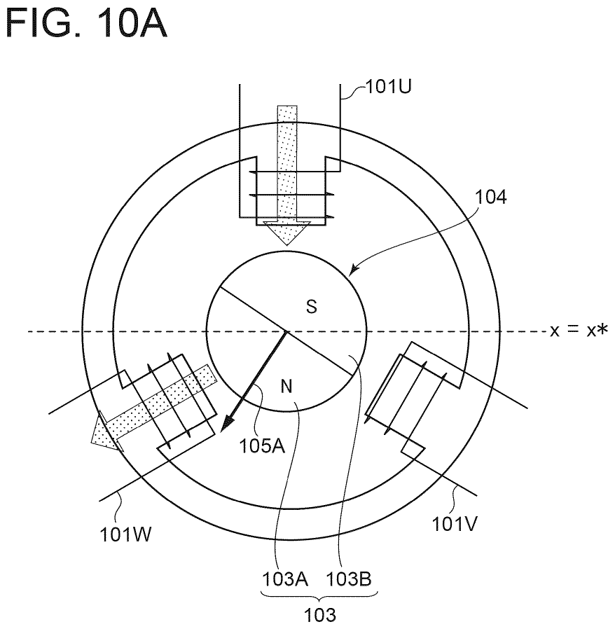

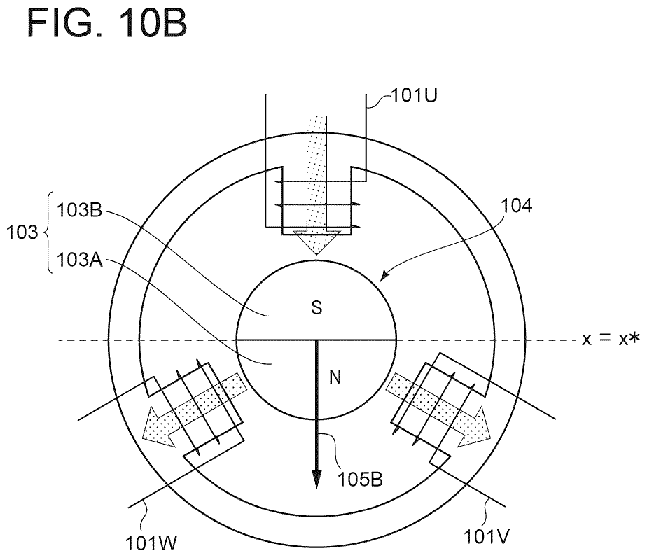

FIG. 10A a diagram showing an example of the energizing pattern in the stop control mode. The energizing pattern in the stop control mode is shown for the “U→W” case in accordance with the example shown in FIG. 7. FIG. 10B is a diagram showing an example of the energizing pattern in the high-precision stop control mode. In FIGS. 10A and 10B, the rotor 104 is shown in an equilibrium position corresponding to the composite flux of the respective energizing patterns.

In FIGS. 10A and 10B, the target angular position x* of the rotor 104 is the angular position x where the boundary between N-pole 103A and S-pole 103B is horizontal and N-pole 103A is below S-pole 103B. In this case, the target angular position x* corresponds to the angular position x of the rotor 104 at an electrical angle of 180 deg in FIG. 5.

As described above, the control device 1 performs control in the feedback control mode with the energizing pattern shown in FIG. 5 until the angular position x of the rotor 104 reaches the target angular position x* (corresponding to an electric angle of 180 deg), and switches to the stop control mode when the angular position x reaches the target angular position x*. In the stop control mode, as shown in FIG. 10A, energizing control is performed with the “U→W” energizing pattern as the last energizing pattern in the feedback control mode. The composite magnetic flux 105A of the magnetic fluxes generated by the coils 101U and 101W of phases U and W brings the rotor 104, which has passed the target angular position x*, closer to the target angular position x*. However, the equilibrium position of the rotor 104 when the composite magnetic flux 105A acts on it deviates slightly from the target angular position x*, as shown in FIG. 10A.

In this regard, in the high-precision stop control mode executed after the stop control mode, the equilibrium position when the composite magnetic flux 105B of the three-phase coil 101 acts on the rotor 104 substantially matches the target angular position x* because the energizing control is performed with the “U→VW” energizing pattern, as shown in FIG. 10B. Therefore, the rotor 104 can be stopped at the target angular position x* with higher precision.

The “U→VW” energizing pattern is the energizing pattern in which the current flowing through the coil 101U of phase U is divided in half to the coil 101V of phase V and the coil 101W of phase W.

The characteristic configurations of the control device 1 (1A, 1B) and the parking lock device 200A according to some embodiments described above are summarized as follows.

[1] A control device (1) according to at least some embodiments is a control device (1) for a motor (100) with a stator (102) including a three-phase coil (101), a rotor (104) including a magnet (103) disposed opposite the stator (102), and a Hall element (H) for generating a detection signal indicating an angular position (x) of the rotor (104). The control device (1) includes: a position determination part (40) configured to determine whether the angular position (x) of the rotor (104) obtained from the detection signal of the Hall element (H) has reached a target angular position (x*) of the rotor (104); and a control mode switching part (50) configured to switch a control mode between a feedback control mode in which energizing control is performed for a pair of phase coils corresponding to the angular position (x) among the three-phase coil (101) at an output decided by feedback control based on a deviation (Δx) between the angular position (x) of the rotor (104) obtained from the detection signal of the Hall element (H) and the target angular position (x*) and a stop control mode in which energizing control is performed for last energized coils that have been energized last in the feedback control mode among the three-phase coil (101). The control mode switching part (50) is configured to switch the control mode from the feedback control mode to the stop control mode when the position determination part (40) determines that the angular position (x) has reached the target angular position (x*).

With the above configuration [1], by operation of the control mode switching part (50), the control mode shifts from the feedback control mode to the stop control mode when the angular position (x) of the rotor (104) reaches the target angular position (x*), and in the stop control mode, energizing control is performed for the coils that have been energized last in the feedback control mode. Therefore, a torque suitable for stopping the rotor (104) at the target angular position (x*) can be applied to the rotor (104) by energizing control in the stop control mode, regardless of receiving the next detection signal of the Hall element (H) indicating a new angular position (xH_3) of the rotor (104), achieving high precision in the stop position of the rotor (104).

[2] In some embodiments, in the above configuration [1], the control device (1) is configured to, in the stop control mode, start the energizing control for the last energized coils after a first specified time (=t3-t2) elapses from the time when the angular position (x) of the rotor (104) obtained from the detection signal of the Hall element (H) reaches the target angular position (x*).

If the energizing control for the last energized coils is started while the angular position (x) of the rotor (104) is at the target angular position (x*), a torque that causes the angular position (x) of the rotor (104) to pass the target angular position (x*) is temporarily applied to the rotor. For example, if the energizing control with the “U→W” energizing pattern is started in the stop control mode at time t2 in FIG. 7, the rotor (104) is given a torque that causes it to pass the target angular position (x*) due to the composite magnetic flux of the “U→W” energizing pattern (composite magnetic flux 105A in FIG. 10A). In this case, even if the stop control mode can finally stop the rotor (104) near the target angular position (x*), the temporary deviation from the target angular position (x*) increases slightly.

In this regard, with the above configuration [2], the energizing control for the last energized coils is started after the first specified time (=t3-t2) elapses from the time when the angular position (x) of the rotor (104) reaches the target angular position (x*). By setting the first specified time (=t3-t2) appropriately, a situation can be avoided in which a torque that causes the angular position (x) of the rotor (104) to pass the target angular position (x*) temporarily acts on the rotor, and a torque that causes the rotor (104) that has passed the target angular position (x*) to rotate backward toward the target angular position (x*) can be selectively applied to the rotor (104).

[3] In some embodiments, in the above configuration [1] or [2], the control device (1) is configured to, in the stop control mode, continue the energizing control for the last energized coils for a second specified time (t4-t3).

With the above configuration [3], by setting the second specified time (=t4-t3)

appropriately, the angular position (x) of the rotor (104) can be reliably returned to near the target angular position (x*) by energizing control for the last energized coils.

[4] In some embodiments, in any of the above configurations [1] to [3], the control device (1) is configured to: in the feedback control mode, perform the energizing control for the pair of phase coils by PWM control based on a first duty ratio decided by the feedback control; and in the stop control mode, perform the energizing control for the last energized coils by PWM control based on a second duty ratio which is a fixed value.

With the above configuration [4], in the feedback control mode, by deciding the first duty ratio according to the deviation (Δx) between the angular position (x) of the rotor (104) and the target angular position (x*), the angular position (x) of the rotor (104) can be quickly brought closer to the target angular position (x*) when it deviates significantly from the target angular position (x*). In contrast, in the stop control mode, by employing a fixed second duty ratio that is independent of the detection signal of the Hall element (H), a torque suitable for returning the rotor (104) to the target angular position (x*) can be applied to the rotor (104) regardless of receiving the next detection signal of the Hall element (H).

[5] In some embodiments, in any of the above configurations [1] to [4], the control mode switching part (50) is configured to switch the control mode to a high-precision stop control mode in which the three-phase coil (101) is energized with a preset energizing pattern corresponding to the target angular position (x*), after executing the stop control mode.

With the above configuration [5], the stop position of the rotor (104) can be brought even closer to the target angular position (x*) by performing control in the high-precision stop control mode following the stop control mode.

[6] A parking lock device (200A) according to at least some embodiments includes: a parking lock gear (210); a motor (104) with a stator (102) including a three-phase coil (101), a rotor (104) including a magnet (103) disposed opposite the stator (102), and a Hall element (H) for generating a detection signal indicating an angular position (x) of the rotor (104); a control device (1) of any of the configurations [1] to [5] for controlling the motor (100); and a parking lock pole (220) configured to be movably driven by the motor (100) between a locked position engaging the parking lock gear (210) and an unlocked position disengaged from the parking lock gear (210).

With the above configuration [6], since the control device (1) of any of the configurations [1] to [5] is employed, it is possible to achieve both rapid reaching of the angular position (x) of the rotor (104) to the target angular position (x*) and high precision in the stop position of the rotor (104), thereby improving both the response and precision of the parking lock device (200A).

In the present specification, the expressions “comprising”, “including” or “having” one constitutional element is not an exclusive expression that excludes the presence of other constitutional elements.

1. A control device for a motor with a stator including a three-phase coil, a rotor including a magnet disposed opposite the stator, and a Hall element for generating a detection signal indicating an angular position of the rotor, the control device comprising:
a position determination part configured to determine whether the angular position of the rotor obtained from the detection signal of the Hall element has reached a target angular position of the rotor; and
a control mode switching part configured to switch a control mode between a feedback control mode in which energizing control is performed for a pair of phase coils corresponding to the angular position among the three-phase coil at an output decided by feedback control based on a deviation between the angular position of the rotor obtained from the detection signal of the Hall element and the target angular position and a stop control mode in which energizing control is performed for last energized coils that have been energized last in the feedback control mode among the three-phase coil,
the control mode switching part being configured to switch the control mode from the feedback control mode to the stop control mode when the position determination part determines that the angular position has reached the target angular position.

2. The control device for a motor according to claim 1,
wherein the control device is configured to, in the stop control mode, start the energizing control for the last energized coils after a first specified time elapses from a time when the angular position of the rotor obtained from the detection signal of the Hall element reaches the target angular position.

3. The control device for a motor according to claim 1,
wherein the control device is configured to, in the stop control mode, continue the energizing control for the last energized coils for a second specified time.

4. The control device for a motor according to claim 1,
wherein the control device is configured to:
in the feedback control mode, perform the energizing control for the pair of phase coils by PWM control based on a first duty ratio decided by the feedback control; and
in the stop control mode, perform the energizing control for the last energized coils by PWM control based on a second duty ratio which is a fixed value.

5. The control device for a motor according to claim 1,
wherein the control mode switching part is configured to switch the control mode to a high-precision stop control mode in which the three-phase coil is energized with a preset energizing pattern corresponding to the target angular position, after executing the stop control mode.

6. A parking lock device, comprising:
a parking lock gear;
a motor with a stator including a three-phase coil, a rotor including a magnet disposed opposite the stator, and a Hall element for generating a detection signal indicating an angular position of the rotor;
the control device according to claim 1 for controlling the motor; and
a parking lock pole configured to be movably driven by the motor between a locked position engaging the parking lock gear and an unlocked position disengaged from the parking lock gear.
